(19) United States
(12) Patent Application Publication
(10) Pub. No.: US 2025/0073876 A1
(43) Pub. Date: Mar. 6, 2025

(54) Unidirectional Clutch Device for Electric Nail Gun

(71) Applicant: Zhejiang Rongpen Air Tools Co., Ltd., Taizhou (CN)

(72) Inventors: Xuejun Xu, Taizhou (CN); Zhonghua Jiang, Taizhou (CN); Xiaorong Li, Taizhou (CN); Xiaopeng Li, Taizhou (CN); Fazheng Yang, Taizhou (CN)

(21) Appl. No.: 18/536,256

(22) Filed: Dec. 12, 2023

(30) Foreign Application Priority Data
Aug. 31, 2023 (CN) 202322349267.9

(51) Int. Cl. B25C 1/06

(52) U.S. Cl. CPC B25C 1/06

(57) ABSTRACT

A unidirectional clutch device for an electric nail gun, comprising a motor, an annular gear fixed above the motor, and a clutch seat. The annular gear contains a central gear and planetary gears. The central gear forms a transmission connection with the motor and meshes with the annular gear through the planetary gears. A lower shim is fixedly attached to the lower part of the annular gear, and an upper shim is positioned at the upper part of the annular gear, movably abutting between the annular gear and the clutch seat. The upper shim has through holes for the pins of the planetary gears. Inside the clutch seat, there is a planet carrier with a cylindrical outer surface, machined with mounting holes for the assembly of the pins. The internal circumference of the clutch seat is machined with needle roller grooves containing needle roller pins.

### FIELD OF THE INVENTION

The present invention relates to a unidirectional clutch device used in electric nail guns.

### BACKGROUND OF THE INVENTION

In nail gun structures powered by gas springs, the motor needs to transfer torque unidirectionally to the lifting wheel through a one-way clutch. This action resets the piston-striking needle assembly from the drive position to the ready position. The one-way clutch limits reverse rotation of the lifting wheel, preventing potential compression collisions between the lifting wheel and the piston-striking needle assembly, thereby protecting the internal structure of the nail gun. A common type of one-way clutch used in electric nail guns, mentioned in the fastener driver scheme powered by gas springs (Patent No. CN208289826U), is detailed in its instruction manual's FIG. 11. In this structure, the annular gear comprises a cylindrical inner part and a toothed inner part as an integral piece. The planet carrier is machined with flanges and inclined surfaces on its circumference. This one-way clutch requires high precision in part manufacturing, leading to frequent scrap due to product precision issues during processing, resulting in higher manufacturing costs and inconvenient assembly, necessitating further improvements.

### SUMMARY OF THE INVENTION

Addressing the deficiencies in the above problems, the present invention provides a unidirectional clutch device for electric nail guns.

To achieve the above objectives, the present invention provides a unidirectional clutch device for electric nail guns, comprising a motor, an annular gear fixed above the motor, and a clutch seat. The annular gear houses a central gear and a plurality of planetary gears. The central gear is in transmission connection with the motor and meshes with the annular gear through the plurality of planetary gears. A lower shim is set below the annular gear, fixedly connected to support the plurality of planetary gears. An upper shim is set above the annular gear, movably abutting between the annular gear and the clutch seat. The upper shim has through holes for the planetary gear pins to pass through. The clutch seat houses a planet carrier with a cylindrical outer surface and mounting holes for tight-fit assembly of the pins. The inner circumference of the clutch seat is machined with the plurality of needle roller grooves, containing needle roller pins. One end of the needle roller groove is further from the cylindrical surface of the planet carrier than the diameter of the needle roller pin, and the other end is closer.

Furthermore, the upper part of the clutch seat is equipped with a seal plate, fixedly connected to the clutch seat, keeping the planet carrier and a plurality of needle roller pins always inside the clutch seat.

Furthermore, the planet carrier has an integrally formed transmission part, extending through the seal plate to achieve power output.

The beneficial effects of the present invention compared to existing technologies include: compact and reasonable structural design, smaller device size, stable power output, and a split-component design for parts. This design effectively reduces scrap in workshop processing, reducing manufacturing costs and increasing profit.

### BRIEF DESCRIPTION OF THE DRAWINGS

FIG. 1 is a perspective view of the unidirectional clutch device for an electric nail gun according to the present invention;

FIG. 2 is a schematic view of the annular gear and clutch seat portion in FIG. 1;

FIG. 3 is a schematic view of the internal structure of the clutch seat (with the seal plate hidden);

FIG. 4 is an exploded view of FIG. 2.

### DETAILED DESCRIPTION OF THE EMBODIMENTS

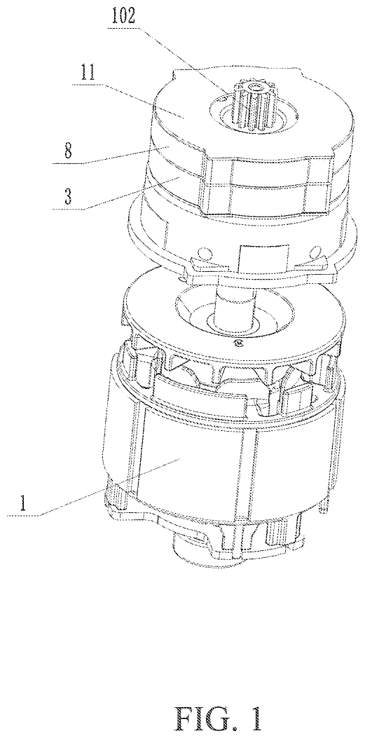

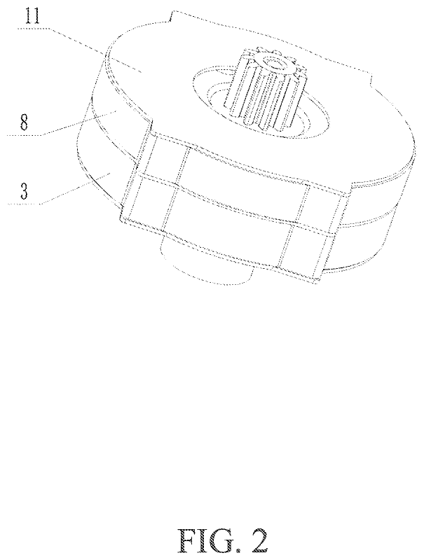

As shown in FIGS. 1-4, an embodiment of the present invention provides a unidirectional clutch device for electric nail guns. It includes a motor (1), an annular gear (3) fixed above the motor (1), and a clutch seat (8). The annular gear (3) houses a central gear (6) and multiple planetary gears (4). The central gear (6) is in transmission connection with the motor (1) and meshes with the annular gear (3) through the planetary gears (4). Below the annular gear (3) is a lower shim (2), fixedly connected to support the planetary gears (4). Above the annular gear (3) is an upper shim (7), which movably abuts between the annular gear (3) and the clutch seat (8) and has through holes (71) for the pins (5) of the planetary gears (4) (the pins (5) are mounted in a gap with the planetary gears (4)). Inside the clutch seat (8) is a planet carrier (10) with a cylindrical outer surface and mounting holes (101) for tight-fit assembly of the pins (5). The clutch seat (8) is internally machined with a plurality of needle roller grooves (81) containing needle roller pins (9). The distance from one end of the needle roller groove (81) to the cylindrical surface of the planet carrier (10) is greater than the diameter of the needle roller pin (9), and the distance at the other end is less. The upper part of the clutch seat (8) has a seal plate (11), fixedly connected to the clutch seat (8), keeping the planet carrier (10) and a plurality of needle roller pins (9) always inside. The planet carrier (10) has an integrally formed transmission part (102) that extends out of the seal plate (11) for power output.

The device is compact and reasonably designed, smaller in size, with stable power output. Its components are designed for split assembly, reducing scrap and manufacturing costs, and increasing profits.

In practical use, for ease of understanding the present invention, it is described in conjunction with the drawings:

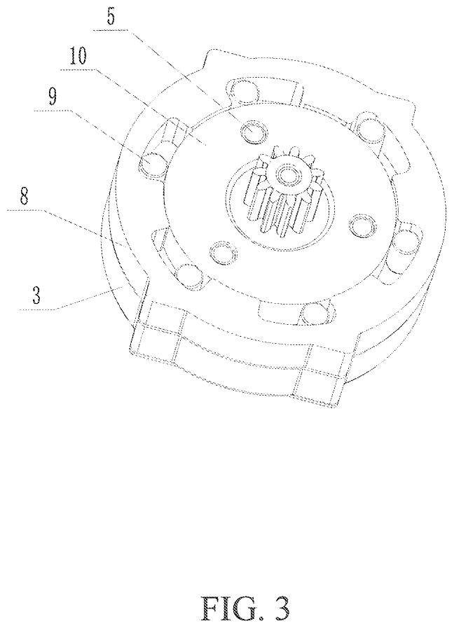

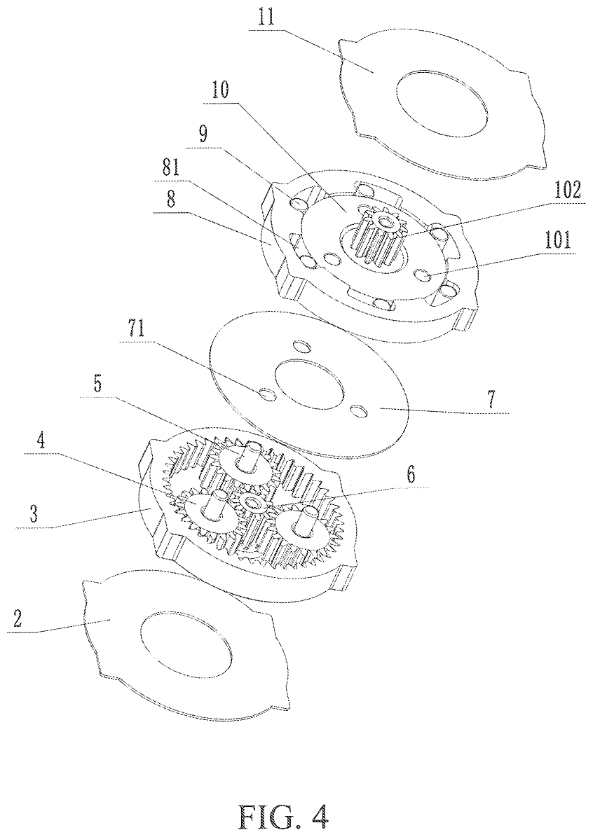

The unidirectional rotation principle of the device is as follows: Referring to FIGS. 3 and 4, in the counterclockwise direction, the distance between the needle roller groove (81) and the cylindrical surface of the planet carrier (10) gradually increases. Thus, when the planet carrier (10) rotates counterclockwise, the needle roller pin (9) does not restrict its free rotation. However, if the torque applied to the planet carrier (10) is in the clockwise direction, the planet carrier (10) gets jammed against the needle roller groove (81) of the clutch seat (8) by the needle roller pin (9), restricting clockwise torque output and rotation.

More specifically, the motor (1) rotates, driving the planetary gears (4) through the central gear (6) for both rotation and revolution. The planetary gears (4), through the action of the pins (5), drive the upper shim (7) and the planet carrier (10) to rotate. The transmission part (102) of the planet carrier (10) outputs the torque of the motor.

The above description is only the preferred embodiment of the present invention and is not intended to limit the scope of the present invention. Any modifications, equivalent substitutions, improvements, etc., made within the spirit and principles of the present invention should be included within the scope of the present invention's protection.

We claim:

1. A unidirectional clutch device for an electric nail gun, comprising:
a motor (1), an annular gear (3) fixed above the motor (1), and a clutch seat (8);
wherein the annular gear (3) houses a central gear (6) and a plurality of planetary gears (4);
the central gear (6) forms a transmission connection with the motor (1), and simultaneously meshes with the annular gear (3) through the plurality of planetary gears (4);
a lower shim (2) is disposed at a lower part of the annular gear (3), fixedly connected to support the plurality of planetary gears (4);
an upper shim (7) is disposed at an upper part of the annular gear (3), movably abutting between the annular gear (3) and the clutch seat (8), with through holes (71) for the pins (5) of the planetary gears (4) to pass through;
the clutch seat (8) houses a planet carrier (10), an outer surface of which is cylindrical; the planet carrier (10) is machined with mounting holes (101) for the tight-fit assembly of the pins (5); an internal circumference of the clutch seat (8) is machined with a plurality of needle roller grooves (81), containing needle roller pins (9); the distance from one end of the needle roller groove (81) to the cylindrical surface of the planet carrier (10) is greater than the diameter of the needle roller pin (9), while the distance from the other end of the needle roller groove (81) to the cylindrical surface of the planet carrier (10) is less than the diameter of the needle roller pin (9).

2. The unidirectional clutch device for the electric nail gun according to claim 1, wherein an upper part of the clutch seat (8) is equipped with a seal plate (11), fixedly connected to the clutch seat (8), ensuring that the planet carrier (10) and the plurality of needle roller pins (9) are always contained within the clutch seat (8).

3. The unidirectional clutch device for the electric nail gun according to claim 2, wherein the planet carrier (10) has an integrally formed transmission part (102), which extends out of the seal plate (11) to facilitate power output.
